(19) United States
(12) Patent Application Publication
(10) Pub. No.: US 2021/0365765 A1
(43) Pub. Date: Nov. 25, 2021

(54) NEUROMORPHIC DEVICE AND METHOD

(71) Applicant: Samsung Electronics Co., Ltd., Suwon-si (KR)

(72) Inventor: Hyunsoo Kim, Yongin-si (KR)

(73) Assignee: Samsung Electronics Co., Ltd., Suwon-si (KR)

(21) Appl. No.: 17/083,827

(22) Filed: Oct. 29, 2020

(30) Foreign Application Priority Data
May 20, 2020 (KR) 10-2020-0060625

(51) Int. Cl. G06N 3/063; G06N 3/08

(52) U.S. Cl. CPC G06N 3/063; G06N 3/08

(57) ABSTRACT

A neuromorphic device and method are provided. A neuromorphic method includes generating a plurality of binary feature maps by multi-channel, based on a plurality of thresholds, binarizing pixel values of an input feature map, providing pixel values of each of the plurality of binary feature maps as input values to a crossbar array circuitry, storing weight values of a machine model in respective synaptic circuits included in the crossbar array circuitry, generating output values of the crossbar array circuitry for the plurality of binary feature maps by implementing multiplications respectively between each of a plurality of the input values and corresponding weight values stored in the synaptic circuits, and generating pixel values of an output feature map by selectively merging the output values.

### CROSS-REFERENCE TO RELATED APPLICATION

This application claims the benefit of Korean Patent Application No. 10-2020-0060625, filed on May 20, 2020, in the Korean Intellectual Property Office, the entire disclosure of which is incorporated herein by reference for all purposes.

### BACKGROUND

### 1. Field

The present disclosure relates to a neuromorphic device and method.

### 2. Description of Related Art

As an example, memory-centric neural network devices refer to computational hardware that may include analyzing a large amount of input data and extracting valid information.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a neuromorphic method includes generating a plurality of binary feature maps by multi-channel, based on a plurality of thresholds, binarizing pixel values of an input feature map, providing pixel values of each of the plurality of binary feature maps as input values to a crossbar array circuitry, storing weight values of a machine model in respective synaptic circuits included in the crossbar array circuitry, generating output values of the crossbar array circuitry for the plurality of binary feature maps by implementing multiplications respectively between each of a plurality of the input values and corresponding weight values stored in the synaptic circuits, and generating pixel values of an output feature map by selectively merging the output values.

The generating of the plurality of binary feature maps may include determining pixel values of a binary feature map by comparing each of the plurality of thresholds with pixel values of the input feature map, and setting respective pixel values of the plurality of binary feature maps to binary values based on results of the comparing.

The generating of the plurality of binary feature maps may further include, for each of the plurality of thresholds, determining whether a pixel value of the input feature map is greater than a threshold, and when the determining of whether the pixel value of the input feature map is greater than the threshold indicates that the pixel value of the input feature map is greater than the threshold determining a corresponding pixel value of a binary feature map to be 1, and when the determining of whether the pixel value of the input feature map is greater than the threshold indicates that the pixel value of the input feature map is not greater than the threshold or when another performed determining of whether the pixel value is less than the threshold or another threshold indicates that the pixel value is respectively less than the threshold or the other threshold, determining the corresponding pixel value of the binary feature map to be 0 or −1.

Each of the pixel values of the output feature map may be represented by multiple bits.

A plural number of bits of a pixel value of the output feature map may have a same plural number of bits as a pixel value of the input feature map.

The generating of the pixel values of the output feature map may include generating pixel values of the output feature map by applying an activation function to the merged output values.

The method may further include providing the output feature map as a new input feature map for another layer of a neural network, as the machine model, generating a plurality of new binary feature maps by multi-channel, based on a plurality of new thresholds, binarizing pixel values of the new input feature map, and providing pixel values of the plurality of new binary feature maps as input values of a new crossbar array circuit of the crossbar array circuitry or a new crossbar array circuitry.

At least one of the plurality of thresholds may have a different value from each of the plurality of new thresholds.

In a general aspect, one more embodiments include a computer-readable medium including instructions, which when executed by a processor, configure the processor to implement any one, any combination, or all operations described herein.

In a general aspect, a neuromorphic device includes an on-chip memory including a crossbar array circuitry, and a processor configured to implement a machine model, wherein, to implement the machine model, the processor is configured to generate a plurality of binary feature maps by multi-channel, based on a plurality of thresholds, binarizing pixel values of an input feature map, provide pixel values of each of the plurality of binary feature maps as input values to the crossbar array circuitry, store weight values of the machine model in respective synaptic circuits included in the crossbar array circuitry, generate output values of the crossbar array circuitry for the plurality of binary feature maps by the crossbar array circuitry implementing multiplications respectively between each of a plurality of the input values and corresponding weight values stored in the synaptic circuits, and generate pixel values of an output feature map by selectively merging the output values.

For the generating of the plurality of binary feature maps, the processor may be configured to determine pixel values of a binary feature map by comparing each of the plurality of thresholds with pixel values of the input feature map, and set respective pixel values of the plurality of binary feature maps to binary values based on results of the comparing.

For the generating of the plurality of binary feature maps, the processor may be configured to, for each of the plurality of thresholds, determine whether a pixel value of the input feature map is greater than a threshold, and when the determination of whether the pixel value of the input feature map is greater than the threshold indicates that the pixel value of the input feature map is greater than the threshold determine a corresponding pixel value of a binary feature map to be 1, and when the determination of whether the pixel value of the input feature map is greater than the threshold indicates that the pixel value of the input feature map is not greater than the threshold or when another performed determination of whether the pixel value is less than the threshold or another threshold indicates that the pixel value is respectively less than the threshold or the other threshold determine the corresponding pixel value of the binary feature map to be 0 or −1.

Each of the pixel values of the output feature map may be represented by multiple bits.

A plural number of bits of a pixel value of the output feature map may have a same plural number of bits as a pixel value of the input feature map.

For the generation of the pixel values of the output feature map, the processor may be configured to generate pixel values of the output feature map by applying an activation function to the merged output values.

The processor may be further configured to provide the output feature map as a new input feature map for another layer of a neural network, as the machine model, generate a plurality of new binary feature maps by multi-channel, based on a plurality of new thresholds, binarizing pixel values of the new input feature map, and provide pixel values of the plurality of new binary feature maps as input values of a new crossbar array circuit of the crossbar array circuitry or a new crossbar array circuitry.

At least one of the plurality of thresholds may have a different value from each of the plurality of new thresholds.

The machine model may be a neural network, and the processor may be further configured to generate a training input feature map of an n-th layer of the neural network by performing forward propagation from a first layer to an (n−1)-th layer of the neural network, generate a plurality of binary training feature maps by multi-channel binarizing pixel values of an input training feature map of the n-th layer based on a plurality of training thresholds, and performing a back propagation from a last layer to the n-th layer of the neural network to train a plurality of kernels corresponding to the plurality of binary training feature maps of the n-th layer, and wherein the storing of the weight value may include obtaining the trained plurality of kernels and storing elements of a least one of the trained plurality of kernels as the weight values stored in the respective synaptic circuits included in the crossbar array circuitry.

The device may be a mobile device, the machine model may be a neural network, and the processor may be further configured to output a classification result by implementing a convolutional layer of the neural network, with respect to the input feature map, and to determine the classification result based on the generated pixel values of the output feature map, and the implementation of the convolution layer may include shifting a feature window across the input feature map.

In a general aspect, a neuromorphic method includes generating an input feature map of an n-th layer of a neural network by performing forward propagation from a first layer to an (n−1)-th layer of the neural network, generating a plurality of binary feature maps by multi-channel, based on a plurality of thresholds, binarizing pixel values of an input feature map of the n-th layer, and performing a back propagation from a last layer to the n-th layer of the neural network to train a plurality of kernels corresponding to the plurality of binary feature maps of the n-th layer.

The generating of the input feature map of the n-th layer may include generating a plurality of binary feature maps by multi-channel binarizing pixel values of an input feature map based on a plurality of thresholds for each layer, from the first layer to the (n−1)-th layer.

In a general aspect, a neuromorphic device includes a processor configured to output a classification result by implementing a convolutional layer of a neural network with respect to an input feature map, and to determine the classification result based on generated pixel values of an output feature map, wherein, for the implementation of the convolutional layer, the processor is configured to provide a first binary feature map, of plural binary feature maps of a same feature window of the input feature map, to a first set of synaptic circuits set with respect to a first kernel of the neural network, provide a second binary feature map, of the plural binary feature maps of the same feature window of the input feature map, to a second set of synaptic circuits set with respect to a second kernel of the neural network, shift from the same feature window to a new same feature window of the input feature map, provide a third binary feature map, of new plural binary feature maps of the new same feature window of the input feature map, to a third set of synaptic circuits set with respect to a third kernel of the neural network, provide a fourth binary feature map, of the new plural binary feature maps of the new same feature window of the input feature map, to a fourth set of synaptic circuits set with respect to a fourth kernel of the neural network, and generate the pixel values of the output feature map based on outputs of the first set of synaptic circuits, the second set of synaptic circuits, the third set of synaptic circuits, and the fourth set of synaptic circuits.

The generating of the pixel values of the output feature map may include generating a pixel value of the output feature map by merging outputs of the first set of synaptic circuits, the second set of synaptic circuits, the third set of synaptic circuits, and the fourth set of synaptic circuits.

The device may further include an on-chip memory including one or more crossbar array circuitries including the first set of synaptic circuits, the second set of synaptic circuits, the third set of synaptic circuits, and the fourth set of synaptic circuits, and wherein at least two of the first set of synaptic circuits, the second set of synaptic circuits, the third set of synaptic circuits, and the fourth set of synaptic circuits are different sets of synaptic circuits.

The processor may be further configured to generate the plural binary feature maps of the same feature window of the input feature map by multi-channel binarizing the same feature window of the input feature map, and generate the plural binary feature maps of the new same feature window of the input feature map by multi-channel binarizing the new same feature window of the input feature map, perform the provision of the first binary feature map, the provision of the second binary feature map, the provision of the third binary feature map, and the provision of the fourth binary feature map respectively by provision of pixel values of each of the first binary feature map, the second binary feature map, the third binary feature map, and the fourth binary feature map as respective input voltage values to the one or more crossbar array circuitries, store weights of the first kernel in the first set of synaptic circuits, weights of the second kernel in the second set of synaptic circuits, weights of the third kernel in the third set of synaptic circuits, and weights of the fourth kernel in the fourth set of synaptic circuits, obtain output values from the one or more crossbar array circuitries resulting from implemented multiplications respectively between the pixel values of each of the first binary feature map and the stored weights of the first kernel in the first set of synaptic circuits, the second binary feature map and the stored weights of the second kernel in the second set of synaptic circuits, the third binary feature map and the stored weights of the third kernel in the third set of synaptic circuits, and fourth binary feature map and the stored weights of the fourth kernel in the fourth set of synaptic circuits, and generate the pixel values of the output feature map by selectively merging the obtained output values.

The processor may be further configured to obtain the first kernel corresponding to the first binary feature map, obtain the second kernel corresponding to the second binary feature map, obtain the third kernel corresponding to the third binary feature map, and obtain the fourth kernel corresponding to the fourth binary feature map.

Other features and aspects will be apparent from the following detailed description, the drawings, and the claims.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an illustration explaining a neural network nodal model;

FIGS. 2A to 2B are diagrams illustrating a neuromorphic method according to one or more embodiments;

FIG. 3 is a diagram explaining an architecture of a neural network according to one or more embodiments;

FIG. 4 is a diagram explaining a relationship between an input feature map and an output feature map in a neural network according to one or more embodiments;

FIGS. 5A to 5B are diagrams illustrating a multiplication calculation performed in a neuromorphic device according to one or more embodiments;

FIG. 6 is a diagram illustrating a convolution operation performed in a neuromorphic device according to one or more embodiments;

FIG. 7 is a diagram explaining a neuromorphic method according to one or more embodiments;

FIGS. 8A to 8B are diagrams illustrating a generating of a binary feature map by a neuromorphic device according to one or more embodiments;

FIG. 9 is a diagram describing a providing of a plurality of binary feature maps to a crossbar array circuit component of a neuromorphic device according to one or more embodiments;

FIG. 10 is a diagram explaining a merging of output values of a crossbar array circuit component in a neuromorphic device according to one or more embodiments;

FIG. 11 is a diagram explaining a neuromorphic device implementation according to one or more embodiments;

FIG. 12 is a flowchart illustrating a neuromorphic method according to one or more embodiments;

FIG. 13 is a view explaining an example of forward and back propagation training in a neural network;

FIG. 14 is a diagram explaining neural network training according to one or more embodiments;

FIG. 15 is a flowchart illustrating neural network training according to one or more embodiments; and

FIG. 16 is a block diagram illustrating a neuromorphic device and a memory, according to one or more embodiments.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms of “first” or “second” are used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

As used herein, the singular forms are intended to include the plural forms as well, unless the context clearly indicates otherwise. The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof. The use of the term “may” herein with respect to an example or embodiment (e.g., as to what an example or embodiment may include or implement) means that at least one example or embodiment exists where such a feature is included or implemented, while all examples are not limited thereto.

In addition, connection lines or connection members between components shown in the drawings are merely illustrative of functional connections and/or physical or circuit connections. In various embodiments, the connections between the components are represented by various functional connections, physical connections, or circuit connections.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein.

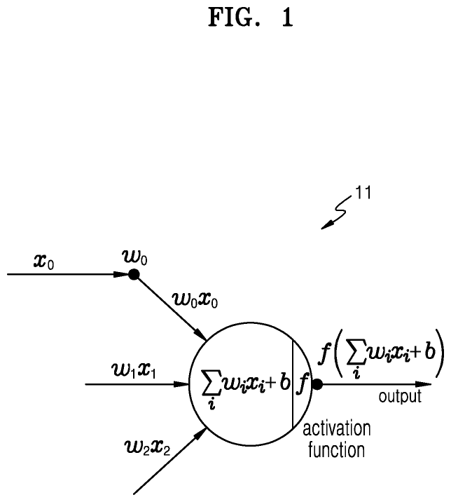

FIG. 1 is a view explaining a neural network nodal model.

The neural network nodal model 11 demonstrates an example neuromorphic calculation of a node of a neural network. For example, the neuromorphic calculation may include a multiplying calculation for multiplying information x₀, x₁, and x₂, respectively output from multiple other nodes of the neural network, by synaptic or connection weights ω₀, ω₁, and ω₂, a summation calculation (Σ) of the resulting ω₀x₀, ω₁x₁, and w₂x₂, and an applying of a bias characteristic function or value b and an activation function f to the result of the summation calculation. The neuromorphic calculation result of the neuromorphic calculation may be considered an activation output of the node, e.g., as an input to a next layer in the neural network. The neural network is a machine model, e.g., a machine leaning model.

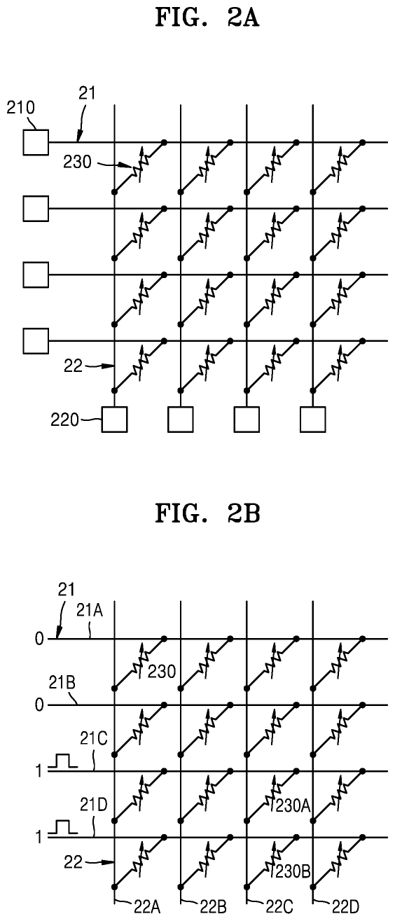

FIGS. 2A to 2B are diagrams illustrating a neuromorphic method according to one or more embodiments.

Referring to FIG. 2A, a neuromorphic device may include a crossbar array circuit component, also referred to herein as a crossbar array circuitry. As an example, a crossbar array circuit component may include a plurality of crossbar array circuits, and each of the crossbar array circuits may be implemented as Resistive Crossbar Memory Arrays (RCA), as a non-limiting example. Each of the crossbar array circuits may include an input 210, e.g., corresponding to a pre-synaptic node, an output 220, e.g., corresponding to a post-synaptic node, and a synaptic circuit 230 that provides a connection between the input 210 and the output 220. A reference herein to a neuromorphic device may also be considered a reference to a plurality of the neuromorphic devices of FIGS. 2A and 2B.

In an example, the crossbar array circuit of the neuromorphic device includes four inputs 210 (e.g., input circuitry or respective circuitries), four outputs 220 (e.g., output circuitry or respective circuitries), and 16 synaptic circuits 230, but these numbers can be variously modified. When the number of inputs 210 is N (where N is a natural number of 2 or more), and the number of outputs 220 is M (where M is a natural number of 2 or more, and may be equal to or different from N), N*M synaptic circuits 230 may be arranged in the matrix form.

Specifically, a line 21 connected to the input 210 and extending in a first direction (for example, a horizontal direction), and a line 22 connected to the output 220 and extending in a second direction (for example, a vertical direction) intersecting the first direction may be provided. Hereinafter, for convenience of description, the line 21 extending in the first direction will be referred to as a row line, and the line 22 extending in the second direction will be referred to as a column line. The plural row lines 21 may be collectively referred to as the row line 21, and the plural column lines 22 may be collectively referred to the column line 22. Similarly, the plural inputs 210 may be collectively referred to as the input 210, and the plural outputs 220 may be collectively referred to as the output 220. The plurality of synaptic circuits 230 may be arranged at each intersection of the row line 21 and the column line 22 to connect a corresponding row line 21 and a corresponding column line 22 to each other, as illustrated.

The input 210 may serve to generate a signal, for example, a signal corresponding to specific data and transmit the signal to the row line 21, and the output 220 may serve to receive and process a synaptic signal that has passed through the synaptic circuit 230 through the column line 22. Each input 210 may, for example, correspond to an input or activation output of a previous node (pre-synaptic node) of the neural network, and each output 220 may correspond to a respective multiplication and accumulate result for information that may be provided as an input to a next node (post-synaptic node). However, whether a particular input 210 includes information of an input or an activation output from a pre-synaptic node, or whether a particular output 220 is information that may determine an input of a post-synaptic node, may be determined by a relative relationship with other nodes of the various layers of the neural network. For example, when the input 210 receives a synaptic signal in relation to plural other nodes, the input 210 may also function as a post-synaptic node for a previous layer of the neural network. Similarly, when the output 220 provides signals in relation to other subsequent nodes, the output 220 may thereby function as a pre-synaptic node for a subsequent layer of the neural network and/or an additional pre-synaptic node of the current layer.

The connection between the input 210 and the output 220 may be made through the synaptic circuit 230. Here, the synaptic circuit 230 may be a hardware element in which electrical conductance or weight is changed according to electrical pulses applied to both ends, for example, voltage or current.

Each synaptic circuit 230 may include, for example, a variable resistance element. The variable resistance element may be an element that can switch between different resistance states according to voltage or current applied to both ends of the element, and may be a single-film structure or a multi-film structure including various materials that can have a plurality of resistance states, for example, transition metal oxides, metal oxides such as perovskite-based materials, phase change materials such as chalcogenide-based materials, ferroelectric materials, ferromagnetic materials, etc., as non-limiting examples. The operation in which the variable resistance element and/or a synaptic circuit 230 changes from a high resistance state to a low resistance state may be referred to as a set operation, and the operation from the low resistance state to the high resistance state may be referred to as a reset operation.

The operation of the neuromorphic device will be described below with reference to FIG. 2B. For convenience of description, the row line 21 is referred to as a first row line 21A, a second row line 21B, a third row line 21C, and a fourth row line 21D in an order from the top, and the column line 22 is referred to as a first column line 22A, a second column line 22B, a third column line 22C, and a fourth column line 22D in order from the left.

Referring to FIG. 2B, in an initial state, all of the synaptic circuits 230 may be in a state in which conductivity is relatively low, that is, in a high resistance state. When some of the synaptic circuits 230 are in a low-resistance state, an initialization operation that changes those low-resistance state synaptic circuits 230 to high-resistance states may be implemented. Each of the synaptic circuits 230 may have a respective preset threshold required for such resistance and/or conductivity changes. When a voltage or current smaller than a preset threshold is applied to both ends of each synaptic circuit 230, the conductivity of the synaptic circuit 230 may not change, while when a voltage or current greater than the preset threshold is applied to the synaptic circuit 230, the conductivity of the synaptic circuit 230 may change.

Thus, in order to perform an operation of outputting data as a result of a specific column line 22, an input signal corresponding to the specific data may enter the row line 21 in response to the respective provisions from the corresponding inputs 210. For example, the input signal may be represented by applications of electrical pulses to any of the row line 21. For example, an input signal may be provided corresponding to the data of ‘0011’, such that for row lines 21A and 21B electric pulses may not be applied corresponding to the indicated ‘0’, for example, and electrical pulses may only be applied to row lines 21C and 21D corresponding to the indicated ‘1’, for example. In this example, one or more of the column line 22 may also be driven with an appropriate voltage or current for output.

As an example, when a column line 22 for outputting data is already determined, that column line 22 may be driven such that the synaptic circuit 230, positioned at the intersection with each of the row lines 21 with electrical pulses corresponding to the respectively indicated ‘1’, is applied with a voltage (hereinafter, the set voltage) having a size equal to or greater than a voltage required for set operation and the remaining column lines 22 may be driven such that the remaining synaptic circuits 230 are applied with a voltage smaller than the set voltage. For example, when the set voltage is Vset and the column line 22 to output the data of ‘0011’ is determined as the third column line 22C, in order that the first and second synaptic circuits 230A and 230B positioned at the intersection of the third column line 22C and the third and fourth row lines 21C and 21D are applied with a voltage of Vset or higher, the electrical pulse applied to the third and fourth row lines 21C and 21D may be greater than or equal to Vset and the voltage applied to the third column line 22C may be 0 V. Accordingly, the first and second synaptic circuits 230A and 230B may be in a low resistance state. The conductivity of the first and second synaptic circuits 230A and 230B in a low resistance state may gradually increase as the number of electrical pulses increases. The size and width of the applied electrical pulse may be substantially constant. In order that the remaining synaptic circuits 230 except the first and second synaptic circuits 230A and 230B are applied with a voltage smaller than Vset, the voltages applied to the remaining column lines, that is, the first, second, and fourth column lines 22A, 22B, and 22D may have a value between 0V and Vset, for example, ½ Vset. Accordingly, resistance states of the remaining synaptic circuits 230 except for the first and second synaptic circuits 230A and 230B may not change.

As another example, the column line 22 for outputting data may not be predetermined. In this case, the current flowing through each column line 22 may be measured while applying electrical pulses corresponding to the data to the row line 21, and the column line 22 that first reaches a preset threshold current, for example, the third column line 22C may be the column line 22 outputting the data.

By the method described above, different data can be output to different column lines 22, respectively.

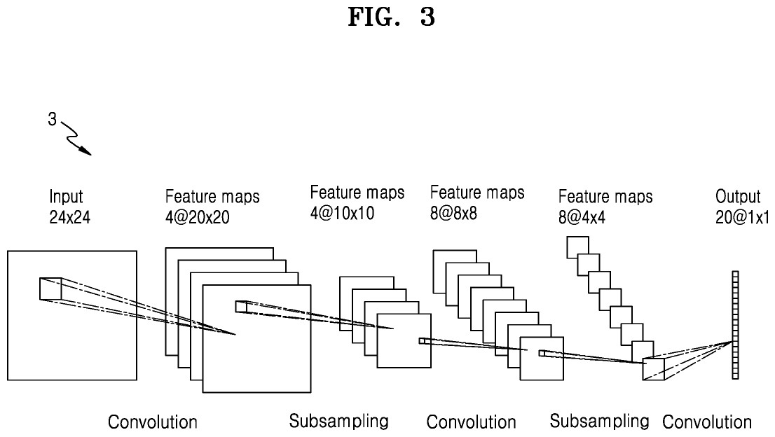

FIG. 3 is a diagram explaining an architecture of a neural network according to one or more embodiments.

Referring to FIG. 3, the neural network 3 may be an architecture of a deep neural network (DNN) or an n-layers neural network. DNN or n-layers neural networks may correspond to Convolutional Neural Networks (CNN), Recurrent Neural Networks (RNN), Deep Belief Networks, Restricted Boltzman Machines, etc., as non-limiting examples. For example, the neural network 3 may be implemented as CNN, but is not limited thereto. In FIG. 3, some convolutional layers are illustrated in the CNN corresponding to the example of the neural network 3. In addition to the convolutional layers shown, two pooling (subsampling) layers and an output layer are shown. In addition, the CNN may further include a fully connected layer, as well as other CNN or any other type of neural network layer.

The neural network 3 may be implemented with an architecture having a plurality of layers. In the neural network 3, a convolution operation with a filter called a kernel is performed on the input feature map, and as a result, an output feature map is output. At this time, the generated output feature map is an input feature map of the next layer, e.g., the illustrated subsampling layer operation, an output of which is an input feature may to the next convolution layer that performs a convolution operation with another kernel. As a result of such convolution operations being repeatedly performed, e.g., with such illustrated subsampling operations, a result of recognition of characteristics of input data through the neural network 3 may be finally output.

For example, if an image of 24×24 pixel size is input to the neural network 3 of FIG. 3, e.g., to the first convolution layer, the results of the first convolution layer with respect to a first kernel may be output as 4 feature channels having sizes of 20×20. Thereafter, as the size of the 20×20 feature maps is reduced through an iterative convolution operations with respective kernels, features of 1×1 size can finally be outputted. By repeatedly performing the respective illustrated convolution operations and subsamplings (or pooling) operations through multiple layers, the neural network 3 may filter and output robust features that can be used to represent the entire image from the input image. Example embodiments further include the use of these output robust features to derive a recognition result of the input image, e.g., by comparison of the output robust features to one or more registered robust features.

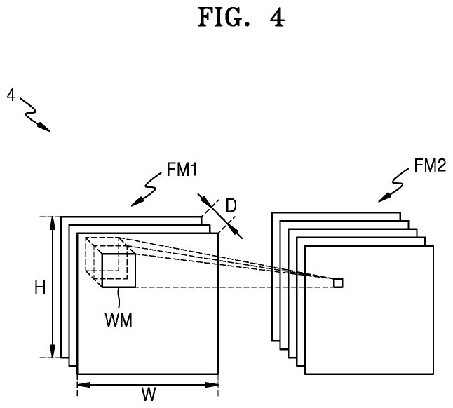

FIG. 4 is a diagram explaining a relationship between an input feature map and an output feature map in a neural network according to one or more embodiments.

Referring to FIG. 4, in a layer 4 of the neural network, the first feature map FM1 may correspond to an input feature map, and the second feature map FM2 may correspond to an output feature map. The feature map may mean a data set in which various characteristics of input data are expressed. The feature maps FM1 and FM2 may have respective pixels in a 2D matrix arrangement or respective pixels in a 3D matrix arrangement. For example, each of the feature maps FM1 and FM2 may have a width W (or a column number), a height H (or a row number), and a depth D. For example, when the feature maps FM1 or FM2 are represented in 3D matrix arrangements, the depth D may correspond to the depth of the corresponding 3D volume. As another example, when either of the respective feature maps FM1 or FM2 are represented in plural 2D matrix arrangements, the depth D may correspond to the number of channels of the respective 2D matrix arrangements. For example, a depth D with a lowest value, e.g., “1”, may refer to a first or illustrated top feature map FM1 or a first or illustrated top feature map FM2, and a respective depth D with a highest value may correspond to a last or the illustrated lowest feature map FM1 or FM2.

The convolution operation for the first feature map FM1 and a kernel may be performed, and as a result, the second feature map FM2 may be generated. The kernel filters characteristics of the first feature map FM1 by performing a convolution operation with the first feature map FM1 using a weight defined in each element of the kernel. The convolution operation is performed through the windows (or also referred to as tiles) of the first feature map FM1, while shifting the kernel over the first feature map FM1 in a sliding window manner, with respect to all depths of the first feature map FM1 as illustrated in FIG. 4. For example, during each shift, each of the weights included in the kernel may be multiplied and added to each pixel of the illustrated overlapped window in the first feature map FM1. Here, for example, the kernel may also have a depth corresponding to the depth of the first feature map FM1, and similar shifted multiplications with respect to the different depths of the kernel and different depths of the FM1 may be performed for the convolution operation to generate one second feature map FM2 depth/channel. Thus, as the first feature map FM1 and the kernel are convolved, one channel of the second feature map FM2 may be generated. In FIG. 4, although one kernel is demonstrated for the generation of the first depth/channel of the second feature map FM2, alternate embodiments include a plurality of kernels that are convolved with the first feature map FM1, respectively, so that the respective illustrated plurality of depths/channels of the second feature map FM2 are generated.

In FIGS. 3 and 4, only the schematic architecture of the neural network 3 is shown for convenience of explanation. However, those skilled in the art can understand that the neural network 3 may be implemented with more or fewer layers, feature maps, kernels, and the like, as illustrated, and its sizes may be variously modified.

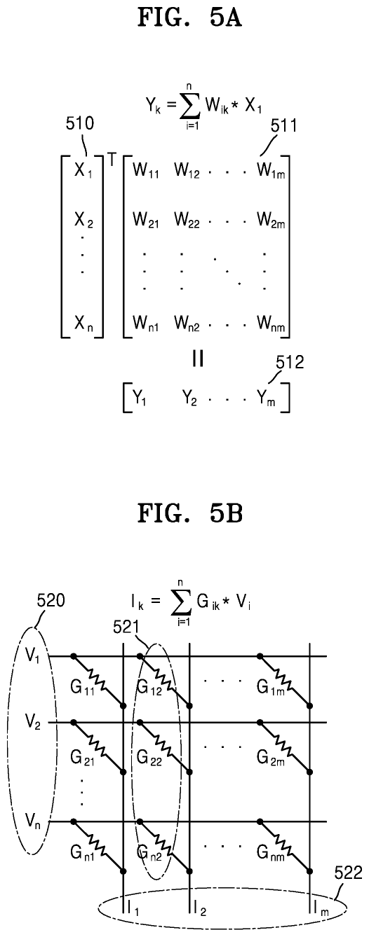

FIGS. 5A to 5B are diagrams illustrating a multiplication calculation performed in a neuromorphic device according to one or more embodiments.

Referring first to FIG. 5A, a convolution operation between an input feature map and a kernel may be performed using vector-matrix multiplication. For example, pixels of the input feature map may be represented by matrix X 510, and weights of the kernel may be represented by matrix W 511. The pixels of the output feature map may be represented by a matrix Y 512 which is a result of multiplication calculation between the matrix X 510 and the matrix W 511.

Referring to FIG. 5B, vector multiplication calculations, such as the multiplication calculation of FIG. 5A, may be performed using a crossbar array circuit of a neuromorphic device. Referring to FIG. 5B, pixels of the input feature map may be received as an input value of a crossbar array circuit, and the input value may be a representative voltage 520. Also, weights of the kernel may be stored in a synaptic circuit, that is, memory cells, and the weights stored in the memory cells may be a representative conductance 521. Therefore, the output value of the crossbar array circuit may be represented by a representative current 522 that is a result of multiplication calculation between the voltage 520 and the conductance 521.

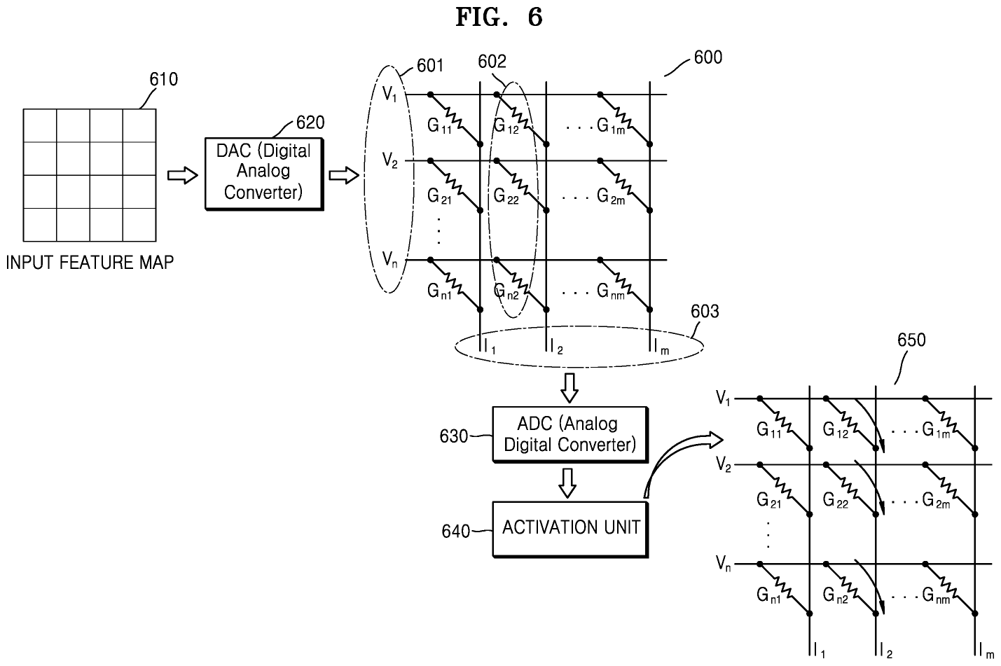

FIG. 6 is a diagram illustrating a convolution operation performed in a neuromorphic device according to one or more embodiments.

A neuromorphic device may be provided with pixels of the input feature map 610, and the crossbar array circuit 600 of the neuromorphic device may be implemented as Resistive Crossbar Memory Arrays (RCA), as a non-limiting example.

The neuromorphic device may receive the input feature map in the form of a digital signal, and convert the input feature map into a voltage in the form of an analog signal using a digital analog converter (DAC). In one embodiment, the neuromorphic device may convert the pixel values of the input feature map to respective voltages using the DAC 620 and provide the respective voltages as the input values 601 of the crossbar array circuit 600.

In addition, weight values of the learned kernel may be obtained and stored in the crossbar array circuit 600 of the neuromorphic device. The weight values may be respectively stored in memory cells of the crossbar array circuit, and the weight values respectively stored in the memory cells may be a representative conductance 602. At this time, the neuromorphic device may calculate an output value by performing a vector multiplication calculation between the voltage 601 and the conductance 602, and the output value may be represented by the current 603. Thus, using the crossbar array circuit 600, the neuromorphic device may be used to output values representing a convolution operation between the input feature map and the kernel.

Since the current 603 output from the crossbar array circuit 600 is an analog signal, in order to consider the current 603 with respect to an input feature map of another crossbar array circuit, the neuromorphic device may use an analog digital converter (ADC) 630. The neuromorphic device may convert an ultimate analog signal current 603 into a digital signal using the ADC 630. In one embodiment, the neuromorphic device may convert the current 603 into a digital signal having the same number of bits as the bits of each of the pixels of the input feature map 610 using the ADC 630. For example, when the input feature map 610 is 4-bit data, the neuromorphic device may convert the current 603 to 4-bit data using the ADC 630. In an example, matrix multiplication may be performed by the crossbar array circuit 600, e.g., where the weights and/or the inputs are in a form that a columnizing of the entire input image or input feature map as the illustrated V1-Vn can result in I1-Im being a convolutional result.

The neuromorphic device may apply an activation function to the digital signal converted by the ADC 630 using the activation unit 640. As the activation function, a Sigmoid function, a Tanh function, and a Rectified Linear Unit (ReLU) function can be used, but the activation function applicable to the digital signal is not limited thereto.

The digital signal to which the activation function is applied may then be used as an input feature map for a next layer of the neural network, e.g., another convolution layer of the neural network, using another crossbar array circuit 650 or reusing the crossbar array circuit 600, for example. When the digital signal to which the activation function is applied is used as an input feature map of another crossbar array circuit 650, the above-described process may be equally applied to other crossbar array circuits 650.

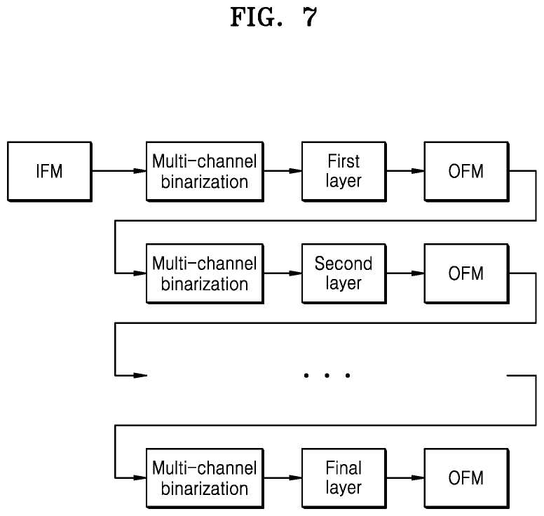

FIG. 7 is a diagram for explaining a neuromorphic method according to one or more embodiments.

The neuromorphic device may binarize the pixel values of the input feature map IFM of the layer of the neural network based on a plurality of thresholds. Herein, this is called multi-channel binarization. The neuromorphic device may generate a plurality of binary feature maps from an input feature map by performing multi-channel binarization.

The neuromorphic device may output calculation results of a plurality of binary feature maps and a plurality of kernels using a crossbar array circuit component. The neuromorphic device may generate an output feature map OFM by merging the output values of the crossbar array circuit component.

The neuromorphic device may perform multi-channel binarization on an input feature map of at least one layer of a neural network. In one embodiment, the neuromorphic device may perform multi-channel binarization for each of the input feature maps of all layers of the neural network. In another example, the neuromorphic device may perform multi-channel binarization only on the input feature map of the first layer of the neural network.

The neuromorphic device can provide the binary values to the crossbar array circuit component as input values by multi-channel binarization of the input data of the neural network, e.g., so that the neural network may be implemented with lower power than traditional neural network approaches.

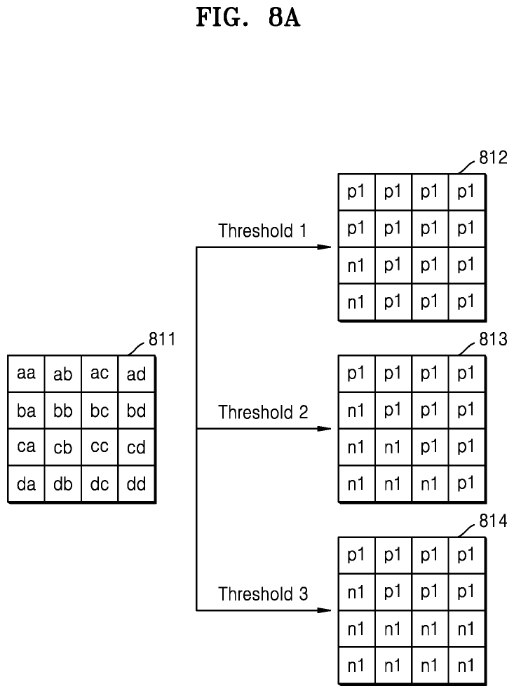

FIGS. 8A to 8B are diagrams illustrating a generating of a binary feature map by a neuromorphic device according to one or more embodiments.

The neuromorphic device performs multi-channel binarization based on a plurality of thresholds, thereby generating a plurality of binary feature maps 812, 813, and 814 from the input feature map 811.

The neuromorphic device may compare a pixel value at a location of the input feature map 811 with a threshold, and determine a pixel value at the same location in the binary feature map. For example, the neuromorphic device may compare the pixel value cd at the (3×4) position of the input feature map 811 and the first threshold threshold 1, and may determine the pixel value at the (3×4) position of the first binary feature map 812.

When the comparison indicates that the pixel value of the input feature map 811 is greater than or equal to the threshold, the neuromorphic device may determine the pixel value of the corresponding binary feature map to be +1. In such an example, when the comparison indicates that the pixel value of the input feature map 811 is smaller than the threshold, the neuromorphic device may determine the pixel value of the corresponding binary feature map to be 0 in an example, or may determine the pixel value of the corresponding binary feature map to be −1, in another example.

Alternatively, when the comparison indicates that the pixel value of the input feature map 811 is equal to the threshold, the neuromorphic device may determine the pixel value of the corresponding binary feature map to be 0 or −1.

For example, in an example where the pixel values of the input feature map 811 are [15, 15, 10, 12; 3, 12, 11, 10; 2, 3, 7, 9; 2, 4, 5, 7] for the illustrated pixel locations [aa, ab, ac, ad; . . . cc, cd; . . . dc, dd], and the first threshold Threshold 1 is 3, the second threshold Threshold 2 is 6, and the third threshold Threshold 3 is 10. The neuromorphic device performs multi-channel binarization to generate a first binary feature map 812 having values of [1, 1, 1, 1; 1, 1, 1, 1; −1, 1, 1, 1; −1, 1, 1, 1] in correspondence to the first threshold, a second binary feature map 813 having values of [1, 1, 1, 1; −1, 1, 1, 1; −1, −1, 1, 1; −1, −1, −1, 1] in correspondence to the second threshold, and a third binary feature map 814 having values of [1, 1, 1, 1, −1, 1, 1, 1; −1, −1, −1, −1; −1, −1, −1, −1] in correspondence to the third threshold, where n1 and p1 in FIG. 8A represent −1 and +1, respectively.

As illustrated in FIG. 8B, when the number of thresholds is Z, Z binary feature maps 822 may be generated from one input feature map 821. That is, when the input feature map 821 has D channels and the threshold is Z, the binary feature maps 822 may have a total of D×Z channels.

The neuromorphic device multi-channel binarizes the input data of the neural network based on a plurality of thresholds with reduced input data loss compared to typical approaches that simply binarize input data into 0 or 1 and perform singular convolution with respect to that binary feature map.

The value and number of the plurality of thresholds may be determined in consideration of the number and size of bits of the input feature map of the neural network. The value and number of the thresholds may be determined in advance. For example, in the above example where values of the input feature map range between 2 and 15, and with 15 being representable with four bits, the use of three thresholds is demonstrated, noting that examples are not limited to the same and alternative numbers of thresholds and distances between thresholds are available.

As the number of thresholds increases, the number of binary feature maps increases, so that the number of thresholds may be determined, e.g., by the neuromorphic device or system, in consideration of the performance of the hardware driving the neural network. As the number of thresholds increases, a binarization loss of the input feature map may also be reduced so that the number of thresholds may be determined in consideration of the set, desired, or appropriate classification performance of the neural network. For example, a neuromorphic device may use a minimum number of thresholds that satisfy a desired classification performance of a neural network.

The plurality of thresholds may have different values. The distribution of a plurality of thresholds may also vary and may be determined in consideration of distribution characteristics of input data. For example, a plurality of thresholds may be determined based on the distribution of pixel values of input data. The plurality of thresholds may have uniform intervals or non-uniform intervals, and may include some uniform intervals and some non-uniform intervals. For example, in order to divide a first range in which the pixel values of the input data are intensively distributed to be relatively close more thresholds may be distributed across the first range, while a second range in which the pixel values of the input data are rarely distributed thresholds in the second range may be apportioned to be relatively sparsely distributed.

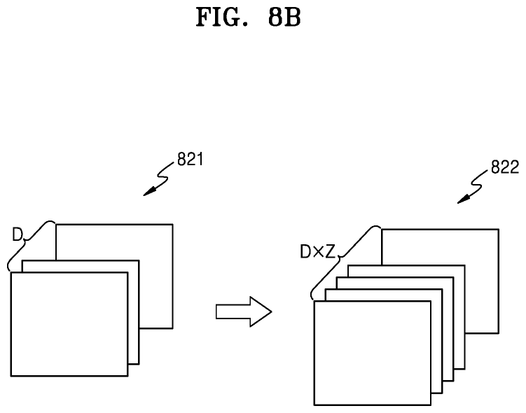

FIG. 9 is a diagram describing a providing of a plurality of binary feature maps to a crossbar array circuit component in a neuromorphic device according to one or more embodiments.

The neuromorphic device may generate a plurality of binary feature maps 921, 922, and 923 by multi-level binarizing the input feature map 910. The neuromorphic device may convert a plurality of binary feature maps 921, 922, and 923 in the form of digital signals into respective voltages in the form of an analog signal using a DAC. The neuromorphic device may provide the respective voltages as an input value of the crossbar array circuit component 930.

In an example, the neuromorphic device may provide the respective voltages obtained by converting the first binary feature map 921 into an analog signal form as an input value of the first crossbar array circuit 931, provide the respective voltages converted from the second binary feature map 922 to an analog signal form as an input value of the second crossbar array circuit 932, and provide respective voltages obtained by converting the third binary feature map 923 into an analog signal form as an input value of the third crossbar array circuit 933.

In an example, the neuromorphic device may provide respective voltages obtained by converting the first binary feature map 921 and the second binary feature map 922 into an analog signal as an input value of the first crossbar array circuit 931. That is, the binary feature map(s) and the crossbar array circuit may be matched according to the number of inputs of the crossbar array circuit.

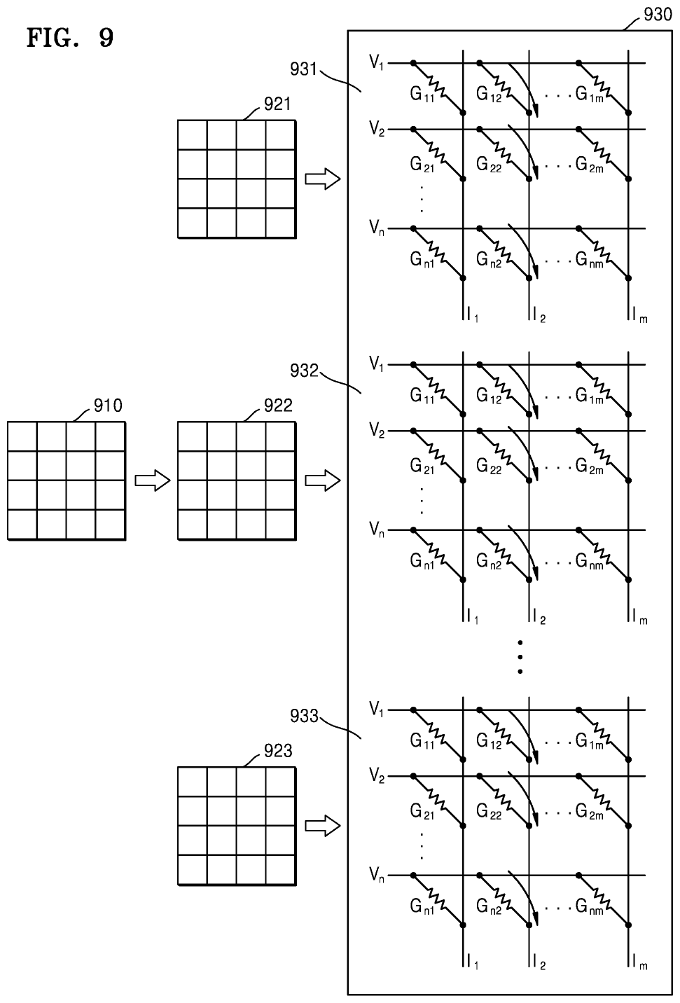

FIG. 10 is a diagram for explaining a merging of output values of a crossbar array circuit component in a neuromorphic device according to one or more embodiments.

The neuromorphic device may perform respective multiplication calculations between the conductance values stored in the synaptic circuits and the respective input values of the crossbar array circuit component 1010. As a result of respective multiplication calculations, respective output values can be accumulated/obtained by each crossbar array circuit.

As an example, the weight elements of the kernel stored in the synaptic circuit may be binary values.

Since each of the crossbar array circuits receives respectively different binary feature maps, the neuromorphic device may merge output values calculated from each of the crossbar array circuits.

In an example, the neuromorphic device may merge output values of corresponding column lines having the same indexing in each crossbar array circuit among output values accumulated/obtained by each of the crossbar array circuits. For example, the neuromorphic device may merge the output value 11 of the first column line of the first crossbar array circuit 1011, the output value 12 of the first column line of the second crossbar array circuit 1012, and the output value 13 of the first column line of the third crossbar array circuit 1013. The neuromorphic device may generate the output feature map 1020 by merging the output values 11 to 13. For example, the neuromorphic device may generate a single pixel value of the output feature map 1020 by merging the output values 11 to 13, and generate a single other pixel value of the output feature map 1020 by merging other output values of a next indexed value from each crossbar array circuit, e.g., where the merged output values 11 to 13 may correspond to an upper left most pixel of the output feature map 1020 and the merged output values of the next indexed value may correspond to a pixel of the output feature map 1020 immediately to the right of the upper left most pixel of the output feature map 1020.

Since the respective output values calculated from the first to third crossbar array circuits 1011, 1012, and 1013 are analog signal types (current values), the neuromorphic device can convert each of the respective output values to digital signals using an ADC. As a non-limiting example, a single ADC may be used for all conversions, respective ADCs of each crossbar array circuit 1011, 1012, and 1013 may be used for conversions with respect to each crossbar array circuit 1011, 1012, and 1013, or ADC circuitry with respect to each column of each crossbar array circuit may be used. The neuromorphic device may then merge the corresponding output values in the converted digital signal form, and then generate pixel values of the output feature map 1020 from the merged output values. For example, pixel values of the output feature map 1020 may be generated by adding together the corresponding output values after they have been converted into digital signal form.

In an alternate example, the neuromorphic device may use the ADC to also apply an activation function to the merged output values. After applying the activation function to the merged output values, the neuromorphic device may generate pixel values of the output feature map 1020 from the output values of the activation function.

In an example, the neuromorphic device may perform multi-channel binarizing of the output feature map 1020 for consideration of the same in a next layer of the neural network, in which case the pixel values of the output feature map 1020 may be in digital form with multiple bits. For example, the number of bits of the pixel of the output feature map 1020 may be 2 or more, or the same as the number of bits of the pixel of the input feature map. Therefore, compared to the previous approaches in which pixel values of the output feature map may be binarized as only binary values, one or more examples herein may thereby provide higher classification accuracy with implementation of the neural network.

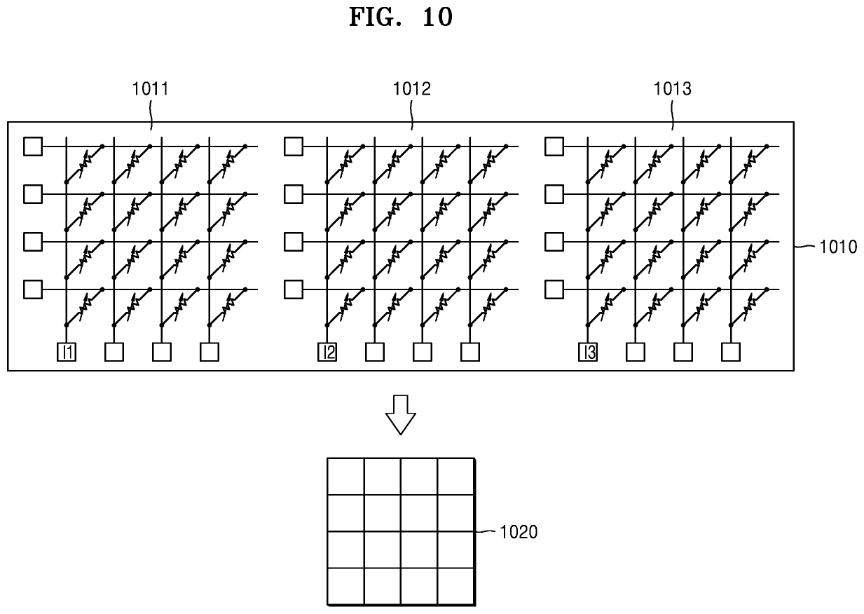

FIG. 11 is a diagram for explaining a neuromorphic method according to one or more embodiments.

The neuromorphic apparatus generates a plurality of binary feature maps 1120 by binarizing (i.e., multi-channel binarizing) the pixel values of the input feature map 1110 based on a plurality of thresholds. The pixel values of each of the plurality of binary feature maps 1120 are provided as input values of the crossbar array circuit component 1130. The neuromorphic device calculates output values of the crossbar array circuit component 1130 by performing respective multiplication calculations between each corresponding input value and respective conductance values stored in a synaptic circuit of the crossbar array circuit component 1130. The neuromorphic device generates the output feature map 1140 by merging the output values of the crossbar array circuit component 1130. For example, the respective inputs from each of the binary feature maps 1120 may be sequentially provided to the crossbar array circuit, and corresponding output values merged, or any two or all three respective inputs from the binary feature maps 1120 may be provided to the crossbar array circuit and column outputs corresponding to a same output pixel may be merged, for each of the output pixels.

The neuromorphic device provides the output feature map 1140 as a new input feature map 1140, e.g., as a new input feature map with respect to a next layer of the neural network. The neuromorphic apparatus generates new binary feature maps 1150 by multi-channel binarizing the pixel values of the new input feature map 1140 based on a plurality of new thresholds. For each of the new binary maps 1150, the neuromorphic device calculates output values of the crossbar array circuit 1160 by performing respective multiplication calculations between each of the corresponding input values to the crossbar array circuit 1160 and respective conductance values stored in a synaptic circuit of the crossbar array circuit 1160. The neuromorphic device generates the output feature map 1170 by merging the output values of the crossbar array circuit 1160.

At least one of the previous plurality of thresholds used to generate the plurality of binary feature maps 1120 may have a different value from at least one of the new plurality of thresholds used to generate the new plurality of binary feature maps 1150. The new plurality of thresholds may be the same as the previous plurality of thresholds, or all of the new plurality of thresholds may be different from the previous plurality of thresholds. The new plurality of thresholds may be dependent on the operation of this next layer of the neural network and/or dependent on expected pixel value distributions of the input feature map 1140. The total number of the plurality of new thresholds may be different from the total number of the previous plurality of thresholds. The values and total number of the new plurality of thresholds may be determined in consideration of the number and size of bits of the new input feature map 1140 for each pixel value. The value and total number of new plurality of thresholds may be determined in advance of implementation of the neuromorphic device in multi-channel binarizing the input feature map 1110.

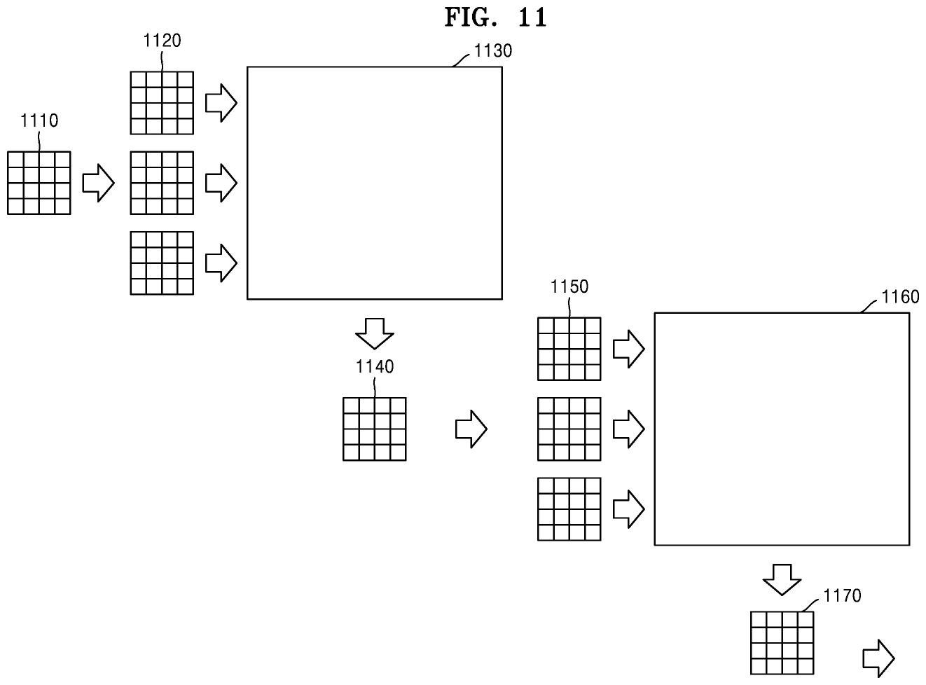

FIG. 12 is a flowchart illustrating a neuromorphic method according to one or more embodiments.

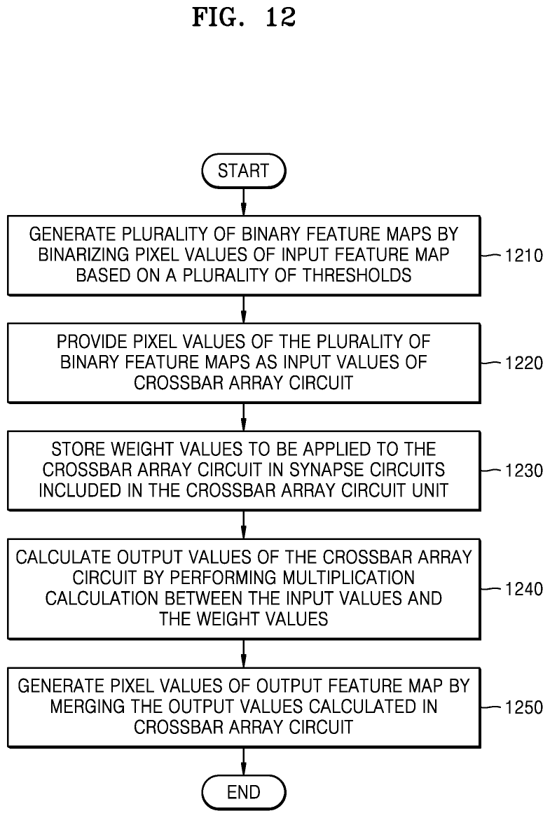

The method of implementing a neural network in a neuromorphic device shown in FIG. 12 is related to the above described examples with respect to FIGS. 1-11, as well as the below described examples with respect to FIGS. 13-16, and thus, the contents described with reference to the previous and following drawings may also be applicable to the method of FIG. 12.

In operation 1210, the neuromorphic device may generate a plurality of binary feature maps by binarizing pixel values of an input feature map based on a plurality of different thresholds. The neuromorphic device may determine the pixel values of each binary feature map by comparing the respective thresholds with the pixel values of the input feature map, e.g., comparing two or more or each of the plurality of thresholds to each of the pixel values of the input feature map. For example, for each of the plurality of thresholds, when the pixel value of the input feature map is greater than any of the plurality of thresholds, the neuromorphic device may set the pixel value of the corresponding binary feature map(s) of the plurality of thresholds to 1. In addition, or as an alternative, when the pixel value or another pixel value of the input feature map is smaller than any of the plurality of thresholds, the neuromorphic device may determine the pixel value of a corresponding binary feature map(s) of these plurality of thresholds to be 0 or −1.

In operation 1220, the neuromorphic device may provide the respective pixel values of each of the plurality of binary feature maps as input values of a crossbar array circuit component. The neuromorphic device may convert the respective pixel values into an analog form and then provide them as input values of the crossbar array circuit component.

In operation 1230, the neuromorphic device may obtain, e.g., from a memory of the neuromorphic device or otherwise input to the neuromorphic device, and store weight values to be applied to the crossbar array circuit component in respective synaptic circuits included in the crossbar array circuit component. The weight values may be convolution kernels corresponding to each of the plurality of binary feature maps that are respectively stored in the synapse circuits of the crossbar array circuit corresponding to each of the plurality of binary feature maps.

In operation 1240, the neuromorphic device may calculate or obtain output values of the crossbar array circuit component by implementing a multiplication calculation between input values and weight values.

In operation 1250, the neuromorphic device may generate pixel values of the output feature map by merging output values calculated by the crossbar array circuit component that correspond to a same pixel of the output feature map. The neuromorphic device may generate pixel values of the output feature map by converting the output values into a digital signal and then merging the corresponding digital signals that correspond to the same pixel of the output feature map. Alternatively, the neuromorphic device may apply an activation function to the merged output values and generate the pixel values of the output feature map from the output values of the activation function.

Table 1 below demonstrates a comparison of classification accuracy of a neural network implemented in a previous approach and a neural network implemented in a method according to an embodiment with input feature map multi-channel binarization.

TABLE 1

| | Previous | Comparison | Example | Example |
|---|---|---|---|---|
| | approach | method | method 1 | method 2 |
| Accuracy | 88.1% | 90.6% | 90.2% | 91.3% |

In the previous approach, 8-bit RGB data was used for an input feature map to the neural network. The previous approach simply binarized the trained weight values of the neural network and singularly binarized the pixel values of the input feature map, so both the binarized weight values and the binarized pixel values represented only two binary values, e.g., 0 or 1. As demonstrated above in Table 1, this previous approach provided an 88.1% accuracy. As a comparison, when only the weight values were binarized, and the neural network was implemented such that the pixel values of the input feature map had 8-bit full precision, such a comparison approach provided a 90.6% accuracy. As demonstrated above in Table 1, an example 1 neuromorphic device according to an embodiment implementing the neural network by binarizing weight values and multi-channel binarizing pixel values of the input feature map with respect to 12 thresholds provided an accuracy of 90.2%. As demonstrated above in Table 1, an example 2 neuromorphic device according to an embodiment implementing the neural network by binarizing weight values and multi-channel binarizing pixel values of the input feature map to 24 thresholds provided an accuracy of 91.3%.

Accordingly, as demonstrated above in Table 1, when the neural network is implemented using the example method 1 or the example method 2 with the neuromorphic device according to example embodiments, it is confirmed that superior classification accuracy can be obtained compared to the previous approach. In addition, when the neural network is implemented using either of the example method 1 or the example method 2 with the neuromorphic device according to example embodiments, it is confirmed that the neural network can be implemented with similar or superior classification accuracy similar to the comparison method that maintains the pixel values of the input feature map with full precision. In addition, it is seen that a higher classification accuracy can be obtained by implementing the neural network using the larger number of thresholds in the example 2 method compared to the multiple number of thresholds in the example 1 method.

FIG. 13 is a view explaining an example of forward and back propagation training in a neural network example.

A node of a neural network, e.g., of a convolution layer 1300, is illustrated in FIG. 13. The convolution layer 1300 of FIG. 13 includes the node with an input training feature map value X, a training kernel value F, and an output training feature map value O. The illustrated neural network node of the example convolution layer 1300 is representative of a plurality of nodes for the convolution layer 1300, as well as a plurality of respective nodes for each of plural layers of the neural network, as described above, for example.

The convolution operation of the entire input training feature map X and the entire training kernel F is performed through forward propagation, and as a result, an output training feature map O can be generated.

For example, the convolution operation of the entire training kernel F and the entire input training feature map X may be performed through a sliding window method. Specifically, pixel values and weight values in the first window of the entire input training feature map X are respectively multiplied and added. Then, the first window moves or shifts in a certain axial direction (for example, the x-axis, y-axis, or z-axis) to configure the second window, the shift may be dependent on a set stride. Then, pixel values and weight values in the second window are respectively multiplied and added. As the convolution operation is continuously performed in this way, and values for each pixel of the output training feature map O are accumulated, ultimately generating the output training feature map O.

A plurality of convolution operations of a plurality of input training feature maps X and a plurality of training kernels F are represented by FIG. 13, so that additional output features map O can also be produced.

When a final output training feature map O is generated, a loss function can be generated by comparing the final output training feature map O with expected results, e.g., previously labeled with respect to the input training feature map. The process of training the neural network can be done in a direction to minimize this loss through iterative changes to the neural network.

In order to minimize a value (loss) of the loss function, the loss gradient

$$\frac{\partial L}{\partial O}$$

may be back propagated. At this time, the loss gradient may mean a gradient of activation.

The convolution operation of the kernel in which the back-propagated loss gradient

$$\frac{\partial L}{\partial O}$$

and elements are rearranged is performed, and as a result, a loss gradient

$$\frac{\partial L}{\partial X}$$

for back propagation to the (previous) next layer may be generated.

The convolution operation of the loss gradient

$$\frac{\partial L}{\partial O}$$

and the input feature map X may be performed, and as a result, a gradient of weight

$$\frac{\partial L}{\partial P}$$

may be generated. And the kernel may thereby be iterative trained.

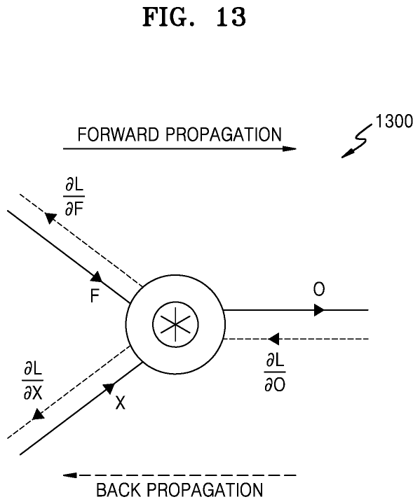

FIG. 14 is a diagram explaining neural network training of training according to one or more embodiments.

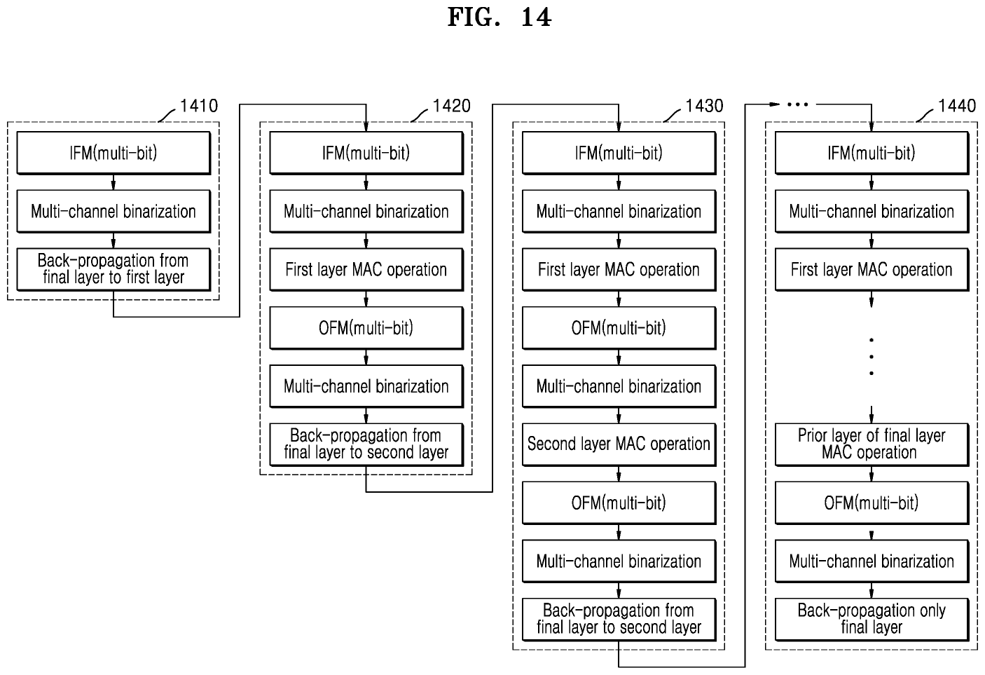

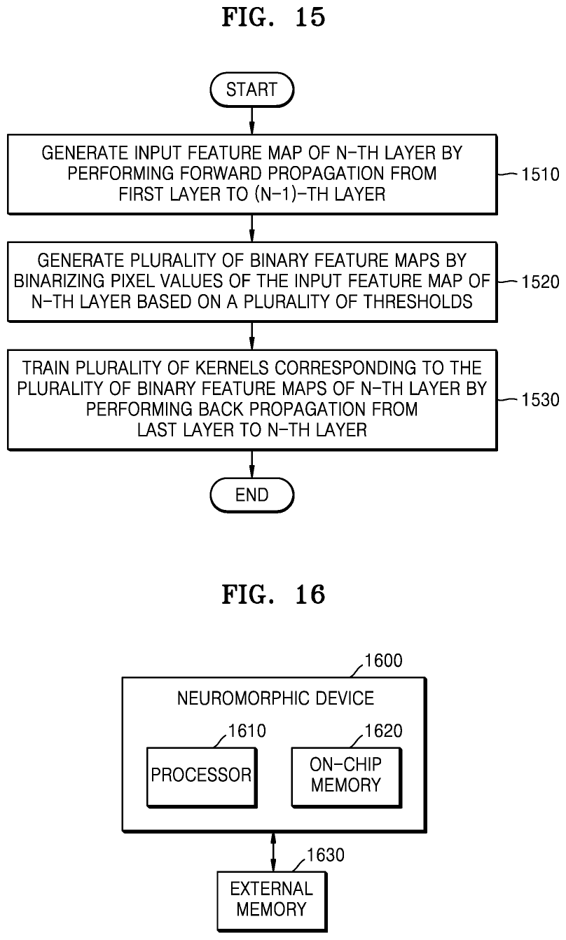

An example includes a neural network learning device, which corresponds to a computing device having various processing functions such as functions of generating a neural network, training (or learning) a neural network, quantizing the data of a neural network, or retraining a neural network. For example, the neural network learning device may be implemented as various types of devices such as a personal computer (PC), a server device, and a mobile device. For example, the neural network learning device may include any of the neuromorphic devices described above. In addition, neuromorphic devices may be, or be include in, the various types of devices such as the personal computer (PC), the server device, and the mobile device configured to perform any, any combination, or all operations described above with respect to FIGS. 1-12. above and FIG. 16 below, alternatively or in addition to the neural network training described above with respect to FIG. 13, here with respect to FIG. 14, and below with respect to FIG. 15.

In operation 1410, the neural network learning device binarizes the pixel values of the input feature map of the first layer of the neural network based on a plurality of thresholds to generate a plurality of binary feature maps. The neural network learning device can train a plurality of kernels respectively corresponding to the plurality of binary feature maps by performing respective back propagation from the last layer of the neural network to the first layer of the neural network, e.g., where the first layer may be the first operational layer for which parameters are trained in the neural network. For example, when the first layer is a convolution layer, pixel values of the input feature map of the first layer may be multiple bits, and the pixel values of the plurality of binary feature maps may be single-bit. In an example, the neural network model for which the back propagation from the last layer to the first layer is performed may be a neural network model in which only the input feature maps of the first layer are multi-channel binarized.

In operation 1420, the neural network learning device may generate an output feature map of the first layer by performing calculation between the plurality of binary feature maps of the first layer and corresponding a plurality of kernels, e.g., such as described above with respect to FIGS. 1-12, the descriptions of which are applicable hereto. The neural network learning device thus provides the output feature map of the first layer as the input feature map of the second layer, and binarizes the input feature map of the second layer based on multiple thresholds, thereby generating a plurality of binary feature maps of the second layer. The neural network learning device can train a plurality of kernels corresponding to a plurality of binary feature maps of the second layer by performing back propagation from the last layer to the second layer. In an example, the neural network model for which the back propagation from the last layer to the second layer is performed can be a neural network model in which the input feature maps of the second layer are multi-channel binarized and the input feature maps from the third layer to the last layer are not multi-channel binarized.

In step 1430, the neural network learning device performs calculation between a plurality of binary feature maps of the first layer and corresponding kernels, performs calculations between a plurality of binary feature maps of the second layer and corresponding kernels, and thereby generates an output feature map of the second layer. The neural network learning device provides the output feature map of the second layer as the input feature map of the third layer, and binarizes the input feature map of the third layer based on multiple thresholds, thereby generating a plurality of binary feature maps of the third layer. The neural network learning device can train a plurality of kernels corresponding to the plurality of binary feature maps of the third layer by performing back propagation from the last layer to the third layer. In an example, the neural network model for which back propagation from the last layer to the third layer is performed can be a neural network model in which the input feature maps of the third layer are multi-channel binarized and the input feature maps from the fourth layer to the last layer are not multi-channel binarized.

The neural network learning device may repeat these descriptions with respect to subsequent layers of the neural network, and thus, finally train a plurality of kernels corresponding to the plurality of binary feature maps of the last layer in operation 1440.

FIG. 15 is a flowchart illustrating neural network training according to one or more embodiments.

Since the method of training the neural network shown in FIG. 15 relates to the embodiments described above in FIGS. 1-14, descriptions above with respect to FIGS. 1-14 are also applicable to the method of FIG. 15, and thus for conciseness those descriptions will not be repeated.

In operation 1510, the neural network learning device may generate an input feature map of the n-th layer by performing forward propagation from the first layer to the n−1-th layer. The neural network learning device respectively binarizes pixel values of each input feature map, based on corresponding thresholds for each layer, from the first layer to the n−1th layer, to generate a plurality of binary feature maps.

In operation 1520, the neural network learning device may generate a plurality of binary feature maps by binarizing pixel values of input feature map to the n-th layer based on a plurality of thresholds. The neural network learning device can generate the output feature map of the n−1th layer by performing forward propagation on up to the n−1th layer, and provide the output feature map of the (n−1)-th layer as an input feature map of the nth layer.

In operation 1530, the neural network learning device can train a plurality of kernels, of the n-th layer, respectively corresponding to a plurality of binary feature maps of the n-th layer by performing back propagation from the last layer to the n-th layer. In an example, in the process of training the neural network, the neural network learning device may perform multi-channel binarization only in the forward propagation operation, and may not perform multi-channel binarization in the back propagation operation.

FIG. 16 is a block diagram illustrating a neuromorphic device and a memory according to one or more embodiments.

Referring to FIG. 16, the neuromorphic device 1600 may include a processor 1610 and an on-chip memory 1620. In the neuromorphic device 1600 shown in FIG. 16, illustrated components are representative of all components and embodiments described above with respect to FIGS. 1-15.

The neuromorphic device 1600 may be, or may be mounted on, a digital system that requires, or selectively operates in, low-power neural network operation, such as smartphones, drones, tablet devices, Augmented Reality (AR) devices, Internet of Things (IoT) devices, autonomous vehicles, robotics, and medical devices, but is not limited thereto.

The neuromorphic device 1600 may include a plurality of on-chip memories 1620, and each of the on-chip memories 1620 is representative of a plurality of crossbar array circuits. The crossbar array circuit may include a plurality of presynaptic nodes, presynaptic node connections, or inputs, a plurality of postsynaptic nodes, postsynaptic node connections, or outputs, and a synaptic circuit, e.g., a memory cell, that provides respective multiplicative connections between the plurality of presynaptic nodes, presynaptic node connections, or inputs and the plurality of postsynaptic nodes, postsynaptic node connections, or outputs. In one or more embodiments, each crossbar array circuit may be a corresponding Resistive Crossbar Memory Arrays (RCA).

The external memory 1630 is hardware and may store various data processed by the neuromorphic device 1600 as well as data to be processed by the neuromorphic device 1600. Also, the external memory 1630 may store applications, drivers, and the like to be driven by the neuromorphic device 1600. The on-chip memories 1620 and/or the external memory 1630 may store parameters of one or more neural networks described herein, which may include plural kernels as well as other connection weights of the one or more neural networks. The external memory 1630 may include random access memory (RAM), such as dynamic random access memory (DRAM), static random access memory (SRAM), and the like, read-only memory (ROM), electrically erasable programmable read-only memory (EEPROM), CD-ROM, Blu-ray, or other optical disk storage, hard disk drive (HDD), solid state drive (SSD), or flash memory, as non-limiting examples.

The processor 1610 may be configured to control overall functions for driving the neuromorphic device 1600 through controlled interaction with a plurality of crossbar array circuits of the on-chip memories 1620. For example, the processor 1610 may control the neuromorphic device 1600 as a whole by executing instructions stored in the on-chip memory 1620 in the neuromorphic device 1600, and/or instructions stored in the external memory 1630. The processor 1610 may be implemented as a central processing unit (CPU), graphics processing unit (GPU), or application processor (AP) provided in the neuromorphic device 1600, but is not limited thereto. The processor 1610 reads/writes various data from/to the external memory 1630 and executes the neuromorphic device 1600 using the read/written data. For example, the processor 1610 may obtain from the on-chip memory 1620 and/or the external memory 1630 kernels of one or more layers of one or more neural networks, and selectively set synaptic circuits of the on-chip memories 1620 to perform multiplicative operations based on multi-channel binarizing of input feature maps for one or more of the layers of the one or more neural networks.

The processor 1610 may generate a plurality of binary feature maps by binarizing the pixel values of the input feature map based on the plurality of thresholds. The processor 1610 may provide pixel values of a plurality of binary feature maps as input values of the included crossbar array circuit component. The processor 1610 may convert pixel values into an analog signal (voltage) using a represented digital analog converter (DAC) of the neuromorphic device 1600.

The processor 1610 may store weight values to be applied to the crossbar array circuit component in synaptic circuits included in the crossbar array circuit component. The weights stored in the synaptic circuits may control a respective conductance of the crossbar array circuit. Further, the processor 1610 may calculate output values of the crossbar array circuit component by performing a multiplication calculation between an input value and kernel values stored in synaptic circuits.

The processor 1610 may generate pixel values of the output feature map by merging output values calculated by the crossbar array circuit component. Furthermore, since the output values (or the result values multiplied by the calculated weight value) calculated by the crossbar array circuit component are in the form of an analog signal (current), the processor 1610 may convert output values to a digital signal using an analog digital converter (ADC). Alternatively, the processor 1610 may apply an activation function to output values converted to a digital signal in an ADC to generate the output feature map. The neuromorphic device 1600 of FIG. 16 may correspond to any or any combination of the neuromorphic devices described above with respect to FIGS. 1-15.

The neuromorphic devices, neuromorphic device 1600, processors, processor 1610, memories, on-chip memory 1620, external memory 1630, crossbar array circuit component or crossbar array circuitry, crossbar array circuits, synaptic circuits, digital to analog converters, analog to digital converters, activation unit, neural network learning device, and other apparatuses, units, modules, devices, and other components described herein with respect to FIGS. 1-16 refer to respective hardware and implementation by such hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-16 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions used herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A neuromorphic method, the method comprising:
generating a plurality of binary feature maps by multi-channel, based on a plurality of thresholds, binarizing pixel values of an input feature map;
providing pixel values of each of the plurality of binary feature maps as input values to a crossbar array circuitry;
storing weight values of a machine model in respective synaptic circuits included in the crossbar array circuitry;
generating output values of the crossbar array circuitry for the plurality of binary feature maps by implementing multiplications respectively between each of a plurality of the input values and corresponding weight values stored in the synaptic circuits; and
generating pixel values of an output feature map by selectively merging the output values.

2. The method of claim 1, wherein the generating of the plurality of binary feature maps comprises determining pixel values of a binary feature map by comparing each of the plurality of thresholds with pixel values of the input feature map, and setting respective pixel values of the plurality of binary feature maps to binary values based on results of the comparing.

3. The method of claim 1, wherein the generating of the plurality of binary feature maps further comprises:
for each of the plurality of thresholds, determining whether a pixel value of the input feature map is greater than a threshold, and when the determining of whether the pixel value of the input feature map is greater than the threshold indicates that the pixel value of the input feature map is greater than the threshold determining a corresponding pixel value of a binary feature map to be 1; and
when the determining of whether the pixel value of the input feature map is greater than the threshold indicates that the pixel value of the input feature map is not greater than the threshold or when another performed determining of whether the pixel value is less than the threshold or another threshold indicates that the pixel value is respectively less than the threshold or the other threshold, determining the corresponding pixel value of the binary feature map to be 0 or −1.

4. The method of claim 1, wherein each of the pixel values of the output feature map are represented by multiple bits.

5. The method of claim 1, wherein a plural number of bits of a pixel value of the output feature map has a same plural number of bits as a pixel value of the input feature map.

6. The method of claim 1, wherein the generating of the pixel values of the output feature map comprises generating pixel values of the output feature map by applying an activation function to the merged output values.

7. The method of claim 1, further comprising:
providing the output feature map as a new input feature map for another layer of a neural network, as the machine model;
generating a plurality of new binary feature maps by multi-channel, based on a plurality of new thresholds, binarizing pixel values of the new input feature map; and
providing pixel values of the plurality of new binary feature maps as input values of a new crossbar array circuit of the crossbar array circuitry or a new crossbar array circuitry.

8. The method of claim 7, wherein at least one of the plurality of thresholds has a different value from each of the plurality of new thresholds.

9. A computer-readable medium comprising instructions, which when executed by a processor, configure the processor to implement the method of claim 1.

10. A neuromorphic device, the device comprising:
an on-chip memory including a crossbar array circuitry; and
a processor configured to implement a machine model,
wherein, to implement the machine model, the processor is configured to:
generate a plurality of binary feature maps by multi-channel, based on a plurality of thresholds, binarizing pixel values of an input feature map;
provide pixel values of each of the plurality of binary feature maps as input values to the crossbar array circuitry;
store weight values of the machine model in respective synaptic circuits included in the crossbar array circuitry;
generate output values of the crossbar array circuitry for the plurality of binary feature maps by the crossbar array circuitry implementing multiplications respectively between each of a plurality of the input values and corresponding weight values stored in the synaptic circuits; and
generate pixel values of an output feature map by selectively merging the output values.

11. The device of claim 10, wherein, for the generating of the plurality of binary feature maps, the processor is configured to determine pixel values of a binary feature map by comparing each of the plurality of thresholds with pixel values of the input feature map, and set respective pixel values of the plurality of binary feature maps to binary values based on results of the comparing.

12. The device of claim 10, wherein, for the generating of the plurality of binary feature maps, the processor is configured to:
for each of the plurality of thresholds, determine whether a pixel value of the input feature map is greater than a threshold, and when the determination of whether the pixel value of the input feature map is greater than the threshold indicates that the pixel value of the input feature map is greater than the threshold determine a corresponding pixel value of a binary feature map to be 1; and
when the determination of whether the pixel value of the input feature map is greater than the threshold indicates that the pixel value of the input feature map is not greater than the threshold or when another performed determination of whether the pixel value is less than the threshold or another threshold indicates that the pixel value is respectively less than the threshold or the other threshold determine the corresponding pixel value of the binary feature map to be 0 or −1.

13. The device of claim 10, wherein each of the pixel values of the output feature map are represented by multiple bits.

14. The device of claim 10, wherein a plural number of bits of a pixel value of the output feature map has a same plural number of bits as a pixel value of the input feature map.

15. The device of claim 10, wherein, for the generation of the pixel values of the output feature map, the processor is configured to generate pixel values of the output feature map by applying an activation function to the merged output values.

16. The device of claim 10, wherein the processor is further configured to:
provide the output feature map as a new input feature map for another layer of a neural network, as the machine model,
generate a plurality of new binary feature maps by multi-channel, based on a plurality of new thresholds, binarizing pixel values of the new input feature map, and
provide pixel values of the plurality of new binary feature maps as input values of a new crossbar array circuit of the crossbar array circuitry or a new crossbar array circuitry.

17. The device of claim 16, wherein at least one of the plurality of thresholds has a different value from each of the plurality of new thresholds.

18. The device of claim 10, wherein the machine model is a neural network,
wherein the processor is further configured to:
generate a training input feature map of an n-th layer of the neural network by performing forward propagation from a first layer to an (n−1)-th layer of the neural network;
generate a plurality of binary training feature maps by multi-channel binarizing pixel values of an input training feature map of the n-th layer based on a plurality of training thresholds; and
performing a back propagation from a last layer to the n-th layer of the neural network to train a plurality of kernels corresponding to the plurality of binary training feature maps of the n-th layer, and
wherein the storing of the weight value includes obtaining the trained plurality of kernels and storing elements of a least one of the trained plurality of kernels as the weight values stored in the respective synaptic circuits included in the crossbar array circuitry.

19. The device of claim 10,
wherein the device is a mobile device and the machine model is a neural network,
wherein the processor is further configured to output a classification result by implementing a convolutional layer of the neural network, with respect to the input feature map, and to determine the classification result based on the generated pixel values of the output feature map, and
wherein the implementation of the convolution layer includes shifting a feature window across the input feature map.

20. A neuromorphic method, the method comprising:
generating an input feature map of an n-th layer of a neural network by performing forward propagation from a first layer to an (n−1)-th layer of the neural network;
generating a plurality of binary feature maps by multi-channel, based on a plurality of thresholds, binarizing pixel values of an input feature map of the n-th layer; and
performing a back propagation from a last layer to the n-th layer of the neural network to train a plurality of kernels corresponding to the plurality of binary feature maps of the n-th layer.

21. The method of claim 20, wherein the generating of the input feature map of the n-th layer comprises generating a plurality of binary feature maps by multi-channel binarizing pixel values of an input feature map based on a plurality of thresholds for each layer, from the first layer to the (n−1)-th layer.

22. A neuromorphic device, the device comprising:
a processor configured to output a classification result by implementing a convolutional layer of a neural network with respect to an input feature map, and to determine the classification result based on generated pixel values of an output feature map,
wherein, for the implementation of the convolutional layer, the processor is configured to:
provide a first binary feature map, of plural binary feature maps of a same feature window of the input feature map, to a first set of synaptic circuits set with respect to a first kernel of the neural network;
provide a second binary feature map, of the plural binary feature maps of the same feature window of the input feature map, to a second set of synaptic circuits set with respect to a second kernel of the neural network;
shift from the same feature window to a new same feature window of the input feature map;
provide a third binary feature map, of new plural binary feature maps of the new same feature window of the input feature map, to a third set of synaptic circuits set with respect to a third kernel of the neural network;
provide a fourth binary feature map, of the new plural binary feature maps of the new same feature window of the input feature map, to a fourth set of synaptic circuits set with respect to a fourth kernel of the neural network; and
generate the pixel values of the output feature map based on outputs of the first set of synaptic circuits, the second set of synaptic circuits, the third set of synaptic circuits, and the fourth set of synaptic circuits.

23. The device of claim 22, wherein the generating of the pixel values of the output feature map includes generating a pixel value of the output feature map by merging outputs of the first set of synaptic circuits, the second set of synaptic circuits, the third set of synaptic circuits, and the fourth set of synaptic circuits.

24. The device of claim 22, wherein the device further comprises an on-chip memory including one or more crossbar array circuitries including the first set of synaptic circuits, the second set of synaptic circuits, the third set of synaptic circuits, and the fourth set of synaptic circuits, and wherein at least two of the first set of synaptic circuits, the second set of synaptic circuits, the third set of synaptic circuits, and the fourth set of synaptic circuits are different sets of synaptic circuits.

25. The device of claim 24, wherein the processor is further configured to:
generate the plural binary feature maps of the same feature window of the input feature map by multi-channel binarizing the same feature window of the input feature map, and generate the plural binary feature maps of the new same feature window of the input feature map by multi-channel binarizing the new same feature window of the input feature map;
perform the provision of the first binary feature map, the provision of the second binary feature map, the provision of the third binary feature map, and the provision of the fourth binary feature map respectively by provision of pixel values of each of the first binary feature map, the second binary feature map, the third binary feature map, and the fourth binary feature map as respective input voltage values to the one or more crossbar array circuitries;
store weights of the first kernel in the first set of synaptic circuits, weights of the second kernel in the second set of synaptic circuits, weights of the third kernel in the third set of synaptic circuits, and weights of the fourth kernel in the fourth set of synaptic circuits;
obtain output values from the one or more crossbar array circuitries resulting from implemented multiplications respectively between the pixel values of each of the first binary feature map and the stored weights of the first kernel in the first set of synaptic circuits, the second binary feature map and the stored weights of the second kernel in the second set of synaptic circuits, the third binary feature map and the stored weights of the third kernel in the third set of synaptic circuits, and fourth binary feature map and the stored weights of the fourth kernel in the fourth set of synaptic circuits; and
generate the pixel values of the output feature map by selectively merging the obtained output values.

26. The device of claim 22, wherein the processor is further configured to obtain the first kernel corresponding to the first binary feature map, obtain the second kernel corresponding to the second binary feature map, obtain the third kernel corresponding to the third binary feature map, and obtain the fourth kernel corresponding to the fourth binary feature map.
